(19) United States
(12) Patent Application Publication
(10) Pub. No.: US 2010/0024220 A1
(43) Pub. Date: Feb. 4, 2010

(54) Deburring Tool For Deburring Drilled Holes

(75) Inventors: Heinrich Heule, Au (CH); Harry Studer, Balgach (CH); Gary Brown, Loveland, OH (US)

Correspondence Address: WOOD, HERRON & EVANS, LLP, 2700 CAREW TOWER, 441 VINE STREET, CINCINNATI, OH, 45202, US

(73) Assignee: Ulf Heule, Belgach (CH)

(21) Appl. No.: 12/472,966

(22) Filed: May 27, 2009

(30) Foreign Application Priority Data
May 28, 2008 (DE) 10 2008 025 642.0

(51) Int. Cl. B26B 27/00; B23B 5/16; B23B 45/06

(52) U.S. Cl. 30/172; 408/124; 408/239 R; 409/140

(57) ABSTRACT

The invention involves a deburring tool for deburring drilled holes, especially simple holes or through-holes, and includes a tool holder (1) with a tool shaft (2) and a anterior part (3), in which an extending recess (19) is placed transversally to the longitude of the tool holder (14), in which recess at least one cutting knife (14, 15) is placed, on whose underside a latch recess (26) is designed, in which a rocker-knife coupling (17, 18) engages, which has a torque-proof connection to the front side of a rocker (7) that is pivotable and located in the tool shaft (2), which rocker is pre-stressed with a spring (6), by which at least one cutting knife (14, 15) is always held under spring tension to the tool shaft (2), characterized by the fact that the rocker-knife coupling (17, 18), in the form of a rigid rocker stud or an elastic rocker spring, engages in the longitude of the tool holder (1) under spring tension in the associated latch recess (26) at the base of at least one cutting knife (14, 15). The task is to simplify knife replacement while retaining the advantages of a conventional deburring tool; in particular, it should be possible without tools and without requiring action on the rocker itself. (FIG. 1)

### SUMMARY

The invention involves a deburring tool for deburring drilled holes, especially simple holes or through-holes.

In a design originating with the same applicant, which is called GHS there, a deburring tool is known that is somewhat cylindrical, and a cylindrical tool holder is described, on whose front end a tool shaft is arranged, in whose anterior portion there is an extending recess in which two facing cutting knives are set and which is in a transverse direction to the longitudinal direction of the tool holder.

Here it is common, on the underside of each cutting knife, to provide a corresponding mounting hole, in which a bolt is engaged. Each bolt is connected in a torque-proof manner to the front side of a rotating rocker that is arranged in the tool shaft. The rocker is pre-stressed with a torsion spring. Because of the torsion spring's pre-stressing, the rocker constantly held the two cutting knives in a withdrawn position spring-weighted to the tool shaft.

When now, for the purpose of deburring, the withdrawn knives are inserted into a corresponding through-hole, there is a corresponding pressure on both cutting knives, brought about by the pre-stressing of the torsion spring, so that the latter will be pressed into the tool shaft under spring tension. In this way the deburring action takes place.

The disadvantage of the conventional deburring tool, however, was that replacement of the two opposing cutting knives was difficult. For the purpose of replacement, the entire rocker had to be pulled back with the help of an eccentric screw and its actuator engaged on the underside of the rocker, in order to disengage the two rocker studs from the associated recess on the underside of each cutting knife.

The problem then was the remounting of a new cutting knife, because the new cutting knife had to be inserted in such a way that the associated rocker stud is inserted into the groove at the bottom of the cutting knife with an accurate fit.

As a result, with the state of the technology, there remains the disadvantage that on a deburring tool of the aforementioned type, it is extraordinarily difficult and problematic to replace knives.

The underlying task of this invention, therefore, is to retain the advantages of the conventional deburring tool while simplifying knife replacement. In particular, it should be possible without tools and without requiring action on the rocker itself.

For resolution of the problem posed, the invention is characterized by the fact that in the longitudinal direction of the tool holder, the rocker studs engage under spring tension into an associated latch recess at the base of the corresponding cutting knife.

With the given technical device, there is the significant advantage that now a latch recess is located at the base or bottom of the corresponding cutting knife and that the corresponding rocker stud is engaged under spring tension in this latch recess, so that simple replacement of the corresponding cutting knife is possible.

In an initial embodiment, the spring engagement of the rocker stud is designed in such a way that both rocker studs are located securely on the guide component of the rocker, and the rocker can be slid axially under spring tension into the front part of the tool holder.

In this way, both rocker studs synchronously engage under spring tension into the corresponding latch recesses at the bottom of the cutting knife.

To replace a cutting knife, it is therefore sufficient to slide the cutting knife still further in the inward direction into the tool shaft, or to slide it with an appropriate tool, in such a way that the spring-loaded bolt is received into the latch recess on a corresponding wedge face, slides along the wedge face (this is designed to be an anti-friction surface) and thus becomes disengaged from the knife's latch recess. Accordingly, with appropriate pressure the knife falls out of the recess in the tool shaft by itself, so that replacement is very simple.

With the embodiment first mentioned, it is therefore significant that the rocker itself is pre-stressed in an axial direction, so that both rigid rocker studs are engaged pre-stressed under spring tension in the corresponding latch recess at the base of the cutting knife.

A second embodiment is designed such that each rocker stud is pre-stressed individually under spring tension and is mounted in an associated recess in the guide component on the front side of the rocker and can be slid axially.

A third embodiment can be designed such that rigid rocker studs themselves can be replaced with a corresponding pressure spring. Thus, each rocker stud is replaced by a corresponding axially pre-stressed pressure spring.

Such springs can be built very simply, in that two pressure springs are coiled inside one another so that one end of the first pressure spring forms one rocker stud and the other end of the pressure spring forms the other rocker stud.

In place of axially pre-stressable pressure springs, of course, other springs can be used, such as leg springs, coil springs or torsion springs.

The invention is not limited to the fact that replacement of two opposingly arranged knives is done in the especially simple manner according to the invention. In a modified embodiment, it is sufficient to use a single cutting knife, and to design for equally simple replacement with one rocker stud under spring tension.

Important to this invention is that, when two cutting knives are used, a particularly advantageous synchronization of the knives takes place. The two knives lie together in the interior space of the tool shaft and thus form surfaces that glide along together while on their exterior sides they rest against associated guide surfaces in the area of the recess on the forward side of the tool shaft. This provides transverse movement of the knives, practically free of play, and the knives mutually brace one another. It is important that the knives form two diametrically opposing cuts, in which the knives always reciprocally align themselves based on the stable engagement of the rocker studs. For example, if the whole assembly moves into a somewhat out-of-round bore or in a slanting bore, the knife with the weaker pressure will be pressed to the edge of the bore, as will by comparison the other knife. This causes a stabilization of the knives, because the knife with the stronger pressure pushes the rocker back, by which the other knife, which had previously not been subject to so much pressure, is automatically moved outward. Based on this, one knife synchronizes the other, because both are mounted on stable rocker studs of a mutual rocker and all in all can turn only as a single unit.

The object of this invention arises not only from the object of the individual patent claims, but also from the combination of the individual patent claims together.

All of the documentation, including the summary of disclosed data and characteristics, especially the spatial design depicted in the drawings, are claimed to have significance as inventions, as long as they are new individually or in combination in relation to the state of the art.

Below, the invention will be explained in more detail by means of several drawings that depict manners of execution. In connection with this, further significant characteristics and advantages significant to the invention arise from the drawings and their descriptions.

Depicted are:

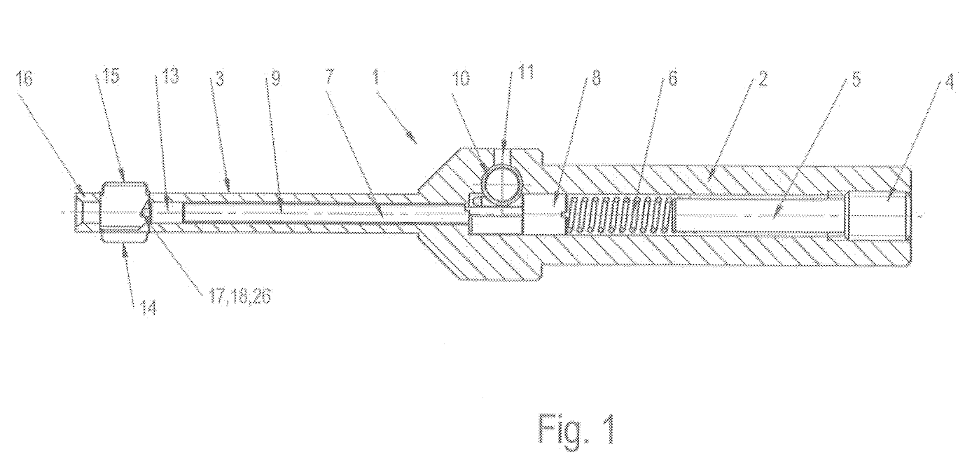

FIG. 1: A longitudinal section of a first embodiment of a deburring tool

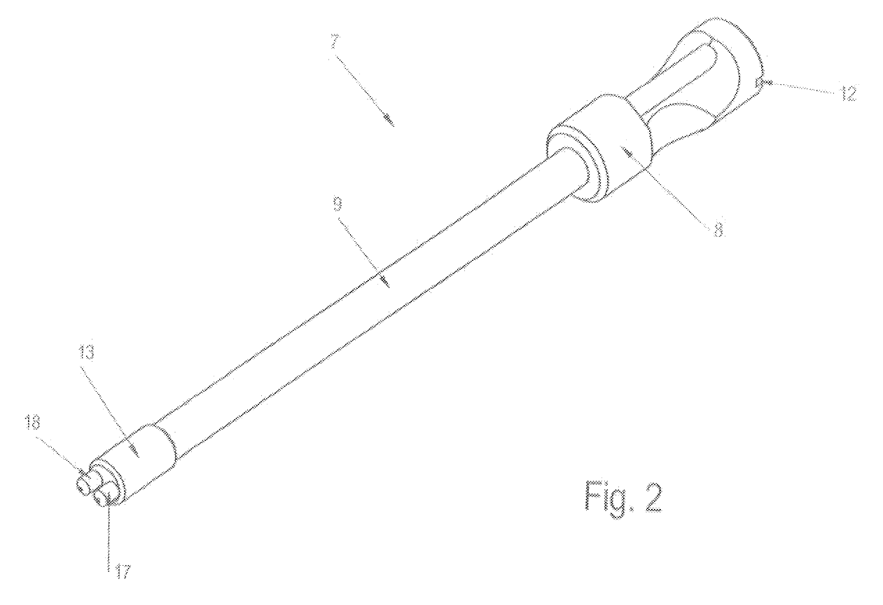

FIG. 2: The rocker according to the first embodiment of the invention

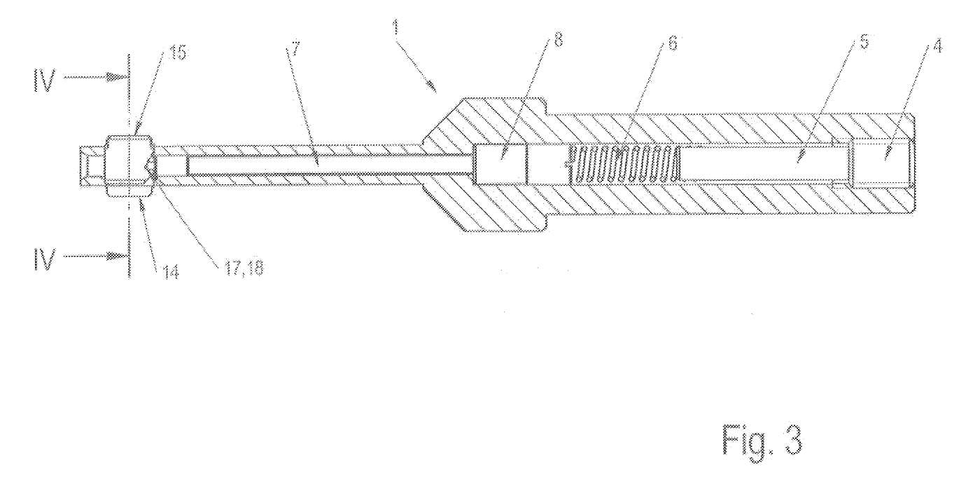

FIG. 3: A modified embodiment versus FIGS. 1 and 2 with a non-adjustable rocker

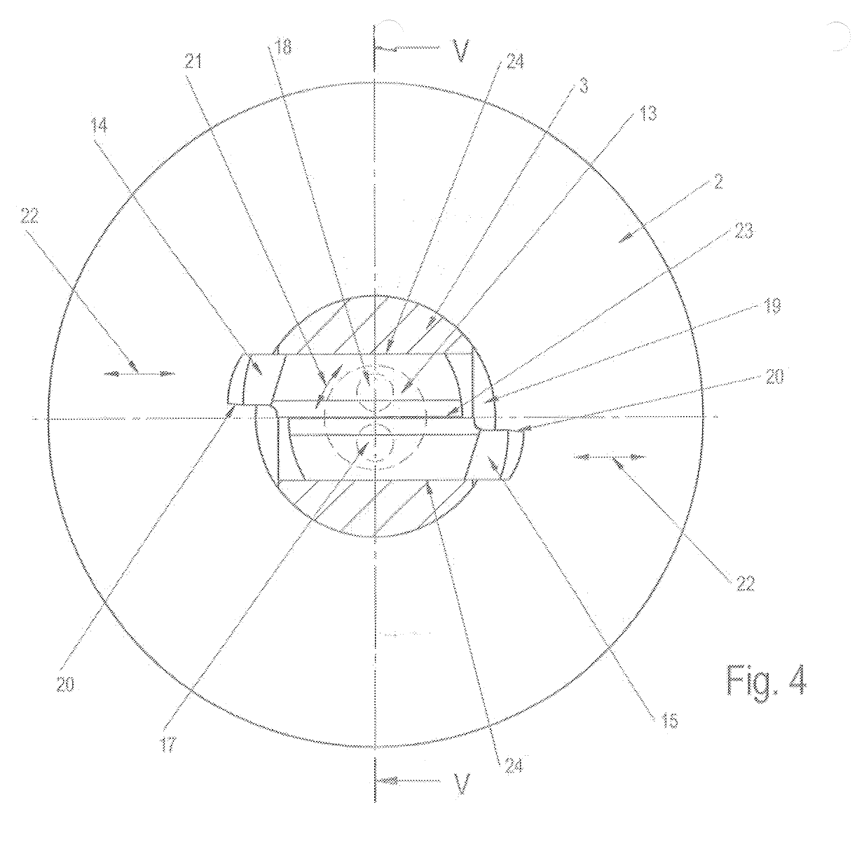

FIG. 4: The section according to line IV-IV in FIG. 3

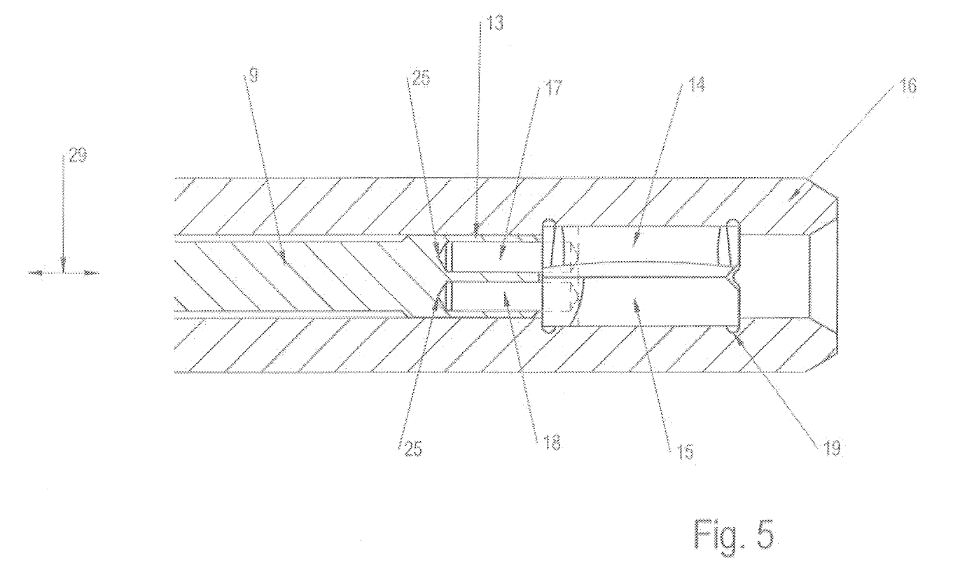

FIG. 5: The section according to line V-V in FIG. 4

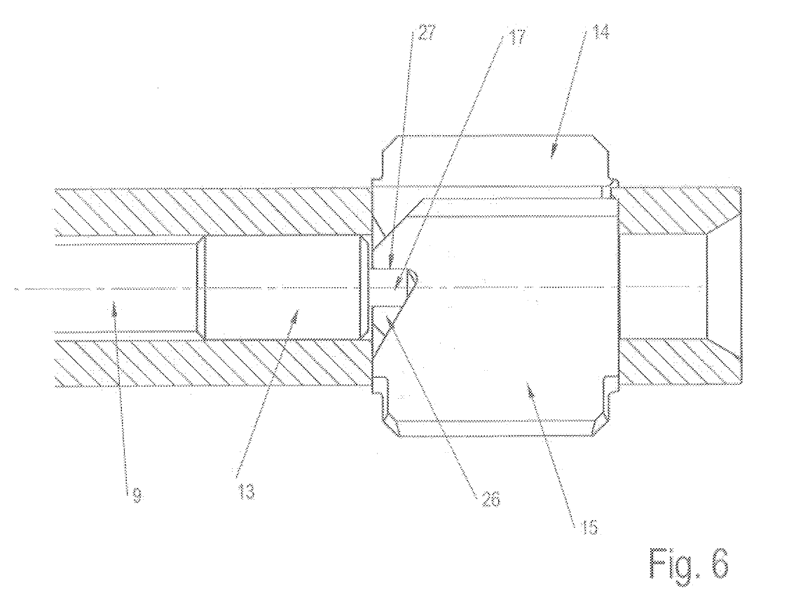

FIG. 6: An enlarged detail depiction of the anterior part of the deburring tool with knife extended

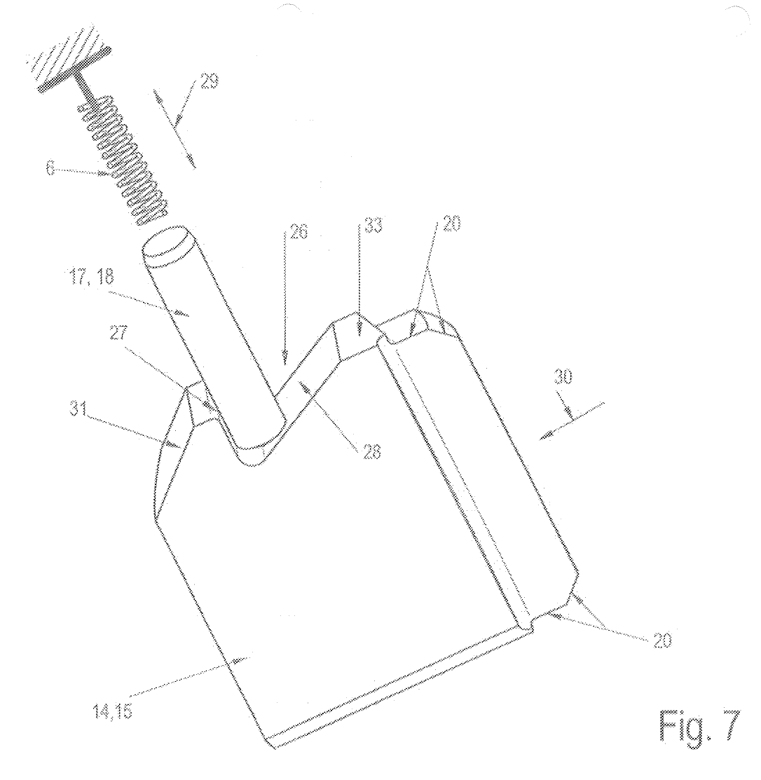

FIG. 7: Diagram of a cutting knife according to the invention with rocker stud engaged

FIG. 8: The enlarged front view of the deburring tool using a single cutting knife

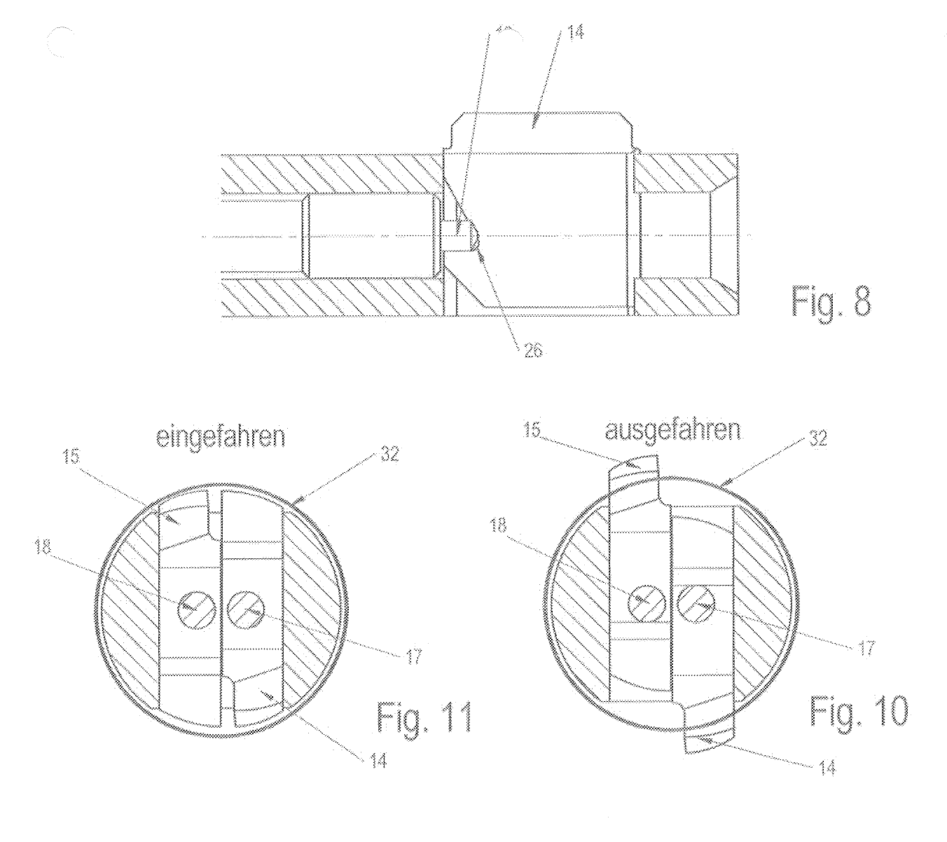

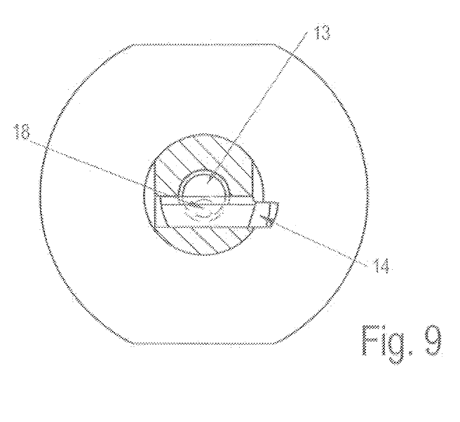

FIG. 9: A section of the design according to FIG. 8 using a single cutting knife

FIG. 10 and FIG. 11: Diagram depiction of the reciprocal synchronization of the shifting of the two opposingly mounted cutting knives.

FIG. 1 depicts a tool holder 1, which consists of a cylindrical tool shaft, onto whose front portion a cylindrical anterior part 3 is joined.

On the tool shaft 2, a longitudinal boring 4 is located, in which a distance bolt 5 is fastened. Against the front side of the distance bolt 5 lies one end of a pressure spring 6, which with its other end engages into a rocker shaft 8 and resiliently pre-stresses this rocker shaft in a specific direction of rotation.

Here the ends of the pressure spring 6 engage in the associated grooves 12 on the rocker shaft 8 in order to pre-stress it with rotation.

The rocker shaft 8 is seated forward through a small-dimensioned anterior part 9, which on its front end in turn passes over a cylindrical guide component 13, on whose face 2 rocker studs 17, 18 are located across a gap from one another.

FIG. 1 shows that a spindle 10 is in place to establish a specific rotation of the rocker shaft 8, in order to move the two facing cutting knives 14, 15, which are more or less in a specific basic position, out of the recess in the anterior part 3 of the tool holder.

Therefore the rocker shaft 8 according to FIG. 2 displays corresponding milled slots in order to allow the spindle 10 to engage.

On the other hand, FIG. 3 shows that the adaptation mechanism of the spindle 10 can also be omitted. Incidentally, FIG. 1 shows that the rotation of the spindle 10 can be set using a locking screw 11.

FIG. 4 shows that the two cutting knives 14, 15 are set facing each other and are manipulated with absolute safety, free of play, in a diametric direction (in the direction of arrows 22) in the associated recess 10 in the anterior part 3 of the deburring tool.

For this, the two cutting knives 14, 15 form a mutual guide surface 23, so that they slide along together in contact with each other. Further, each cutting knife 14, 15 lies with a facing exterior guide surface 24 against the interior side of the wall of the recess 19 in the anterior part 3 of the deburring tool.

It can be seen that a rocker stud 18 engages in an associated latch recess 26 in one cutting knife 14, while the other rocker stud 17 engages in a similar latch recess 26 in the other cutting knife 15.

FIG. 1 shows that the recess 19 in the anterior part 3 of the tool holder 1 is enclosed at the top by a headpiece 16.

This ensures that the longitudinally upward lying faces of the cutting knives 14, 15 can be slid lengthwise on a corresponding guide surface in the headpiece 16.

If, for example, the rocker 7 is now adjusted in the direction of rotation 21, and indeed against the force of the pressure spring 6, then accordingly the rocker studs 17, 18 are adjusted in the marked direction of rotation 21, and the cutting knives 14, 15 are moved in and out according to the directions of the arrows 22 from the recess in the anterior part 3.

Each cutting knife 14, 15 thus reveals its associated cutting edges 20.

The depiction in FIG. 4 shows that, with a corresponding orthogonal pressure on the cutting edges 20, the knives 14, 15 reciprocally support each other and synchronously move into the recess 19 in the anterior part of the deburring tool without any play.

FIG. 5 shows an expanded lateral view of the assembly according to FIG. 3, in which it can be seen that the rocker studs 17, 18 are pressed into the associated drilled holes 25 on the face of the anterior part 9 of the rocker 7.

FIG. 6 shows the easy replaceability of the assembly, where it can be seen that in each case a rocker stud 17, 18 engages by spring tension (see the arrow direction 29 in FIG. 5) in an associated latch recess 26 on the bottom side of the cutting knife 14, 15.

FIG. 7 shows further details of the interchangeable mounting of this type of cutting knife 14, 15. Because the cutting knives 14, 15 are formed identically, as is their mounting, it is sufficient to describe the interchangeable mounting of a single cutting knife, because the other cutting knife is formed exactly the same.

FIG. 7 shows that a spring-tensed rocker stud 17, 18 now engages under spring tension in the area of the latch recess 26, and thus lies in its operating position against the stop edge 27. Therefore the knife operates stably with its cutting edges 20 for deburring the edge of a corresponding hole, while the corresponding rocker stud 17, 18 lies stably against the stop edge 27.

If, on the other hand, the cutting knives 14, 15 are replaced, then it is sufficient to place appropriate pressure by hand or with an auxiliary tool in the direction of the arrow 30 on this cutting knife 14, 15, and in this way the rocker stud 17, 18 slides along the wedge face 28 of the latch recess 26 and in the area of the guide surfaces 33 becomes disengaged from the cutting knife 14, 15. The latter can therefore be replaced very easily. When the cutting knives 14, 15 perform a deburring action, the rocker studs 17, 18 always slide in the area of the wedge face 28, without disengaging from this wedge face. Not until appropriate force is used on the corresponding cutting knife 14, 15 in the direction of the arrow 30 does the rocker stud 17, 18 disengage from the wedge face 28 and reach the area of the guide surface 33. Thus the knife falls out automatically, so to speak, in the direction of the arrow out of the recess 19 of the deburring tool.

Incidentally, the same applies to the opposing cutting knife, because the in the corresponding embodiment according to FIGS. 1 through 3, the rocker 7 is completely spring pre-stressed and the rocker studs 17, 18 are rigidly fixed to the rocker.

However, FIG. 7 indicates still another design example in which it can be seen that the rocker itself cannot be slid axially and is not rotationally pre-stressed, but rather that each rocker stud 17, 18 is separately and individually pre-stressed with the help of an axial pressure spring, which can be pulled forward and backward in the direction of the arrow 29.

In this way also the cutting knives can be replaced very easily.

Therefore, instead of the assembly with rigid rocker studs on a rocker that is completely axially spring stressed, a corresponding storage and axial shifting of each individual rocker stud 17, 18 can be provided.

FIGS. 8 and 9 show that instead of using two identical cutting knives 14, 15, just an individual cutting knife, e.g., a cutting knife 14 can be used. Otherwise the same explanations apply to the same parts.

It is significant here also that stable guidance of the individual cutting knife 14 in the recess 19 of the deburring tool takes place.

If a new knife should be inserted into the recess 19, then the lead-in chamfer 31 makes it possible for the knife to be simply installed in the recess in the direction of the arrow 30, by which the rocker stud 17, 18 or the entire rocker is pushed back under spring tension, and in so doing shifts itself axially far enough that the rocker stud 17, 18 has moved over the lead-in chamfer 31 and engages to rest on the other side of the stop edge 27 in the area of the latch recess 26.

FIGS. 10 and 11 provide a closer look at the reciprocal synchronization of the two opposing knives 14, 15. In FIG. 10 the two cutting knives 14, 15 have moved out into a cutting action, and it can be seen that the rocker 7 has moved under spring tension with the rocker stud 17, 18 in the direction of the arrow 21.

As soon as the two cutting knives 14, 15 move into the drilled hole, the rocker 7 rotates against the adjusted spring tension of the pressure spring 6 in the direction of the arrow 21 and the cutting knives 14, 15 are brought into the tool bore 32 against the spring tension. There they no longer perform any cutting or deburring action.

The advantage of this invention is also that the cutting knives 14, 15 are especially easy to replace. For this purpose it is designed that the rocker stud 17, 18 or the entire rocker 7 engages in an axial direction under spring pre-stressing into the appropriate latch recess 26 at the base of the corresponding cutting knife 14, 15, so that the cutting knives can be exchanged through simple pressure in a radial direction.

### Key to Drawings

1 tool holder

2 tool shaft

3 anterior part

4 longitudinal boring

5 distance bolt

6 pressure spring

7 rocker

8 rocker shaft

9 anterior part

10 spindle

11 locking screw

12 groove

13 guide component

14 cutting knife

15 cutting knife

16 headpiece

17 rocker stud

18 rocker stud

19 recess (anterior part 3)

20 cutting edge

21 direction of rotation

22 direction of arrow

23 guide surface (knife 14, 15)

24 guide surface (of 19)

25 drilled hole

26 latch recess

27 stop edge

28 wedge face

29 direction of arrow

30 direction of arrow

31 lead-in chamfer

32 workpiece bore hole

33 guide surface

1. A deburring tool for deburring drilled holes, especially single holes or through-holes, which includes a tool holder (1) with a tool shaft (2) and an anterior part (3), in which a recess (19) is placed transversally to the longitude of the tool holder (1), in which recess at least one cutting knife (14, 15) is placed, on whose underside a latch recess (26) is designed, in which a rocker-knife coupling (17, 18) engages, which has a torque-proof connection to the front side of a rocker (7) that is pivotable and located in the tool shaft (2), which rocker is pre-stressed with a spring (6), by which at least one cutting knife (14, 15) is always held under spring tension to the tool shaft (2), characterized by the fact that the rocker-knife coupling (17, 18) engages along the longitude of the tool holder (1) under spring tension in the associated latch recess (26) at the base of at least one cutting knife (14, 15).

2. Deburring tool according to claim 1, characterized by the fact that the rocker-knife coupling (17, 18) is a rocker stud (17, 18) that, securely located on the guide component (13) of the rocker (7) and the rocker (7), is mounted under spring tension and can be slid axially in the anterior part (3) of the tool holder (1).

3. Deburring tool according to claim 1, characterized by the fact that the rocker-knife coupling (17, 18) is a rocker stud (17, 18) and the rocker (7) itself is pre-stressed axially under spring tension, so that the rigid rocker stud (17, 18) engages synchronically spring pre-stressed in the corresponding latch recess (26) at the base of the cutting knife (14, 15).

4. Deburring tool according to one of the claims 1 through 3, characterized by the fact that the rocker-knife coupling (17, 18) is a rocker stud (17, 18), which is individually spring pre-stressed and is mounted and axially slidable in an associated recess (25) in the guide component (13) on the anterior side of the rocker (7).

5. Deburring tool according to claim 1, characterized by the fact that the rocker-knife coupling (17, 18) represents an axially elastic rocker spring.

6. Deburring tool according to claim 5, characterized by the fact that two cutting knives (14, 15) are in place and the axially elastic rocker spring is formed from two pressure springs, that are coiled into one another, so that one end of the rocker spring engages in the latch recess (26) of the first cutting knife (14) and the other end of the rocker spring engages in the latch recess (26) of the second cutting knife (15).

7. Deburring tool according to one of the claims 1 through 6, characterized by the fact that the two cutting knives (14, 15) lie against one another in the interior space of the tool shaft (2) and thus form guide surfaces (23) that slide against one another, while on their outer sides they lie against one another on corresponding guide surfaces (24) in the area of the recess (19) on the front side of the tool shaft (2).

8. Deburring tool according to one of the claims 1 through 7, characterized by the fact that the cutting knives (14, 15) form two diametrically opposite cuts (20), with which the cutting knives (14, 15) always reciprocally align the rocker-knife coupling (17, 18) due to their stable engagement.
